(19) United States
(12) Patent Application Publication
(10) Pub. No.: US 2026/0143107 A1
(43) Pub. Date: May 21, 2026

(54) ELECTRONIC DEVICE AND NON-TRANSITORY MACHINE-READABLE MEDIUM FOR DECODING AND/OR ENCODING VIDEO DATA

(71) Applicant: SHARP KABUSHIKI KAISHA, Sakai City (JP)

(72) Inventor: YU-CHIAO YANG, New Taipei City (TW)

(21) Appl. No.: 19/341,612

(22) Filed: Sep. 26, 2025

Related U.S. Application Data
(60) Provisional application No. 63/699,780, filed on Sep. 26, 2024.

(51) Int. Cl. H04N 19/105; H04N 19/167; H04N 19/176; H04N 19/196

(52) U.S. Cl. CPC H04N 19/105; H04N 19/167; H04N 19/176; H04N 19/196

(57) ABSTRACT

A method of decoding/encoding video data is provided. The method determines a chroma block location of a chroma block unit from an image frame of the video data; a guiding block vector for the chroma block unit; and a guided reference block from the image frame based on the guiding block vector. The method derives a CCP filter based on neighboring samples, neighboring the guided reference block, as an on-the-fly CCP candidate of the chroma block unit. The method then determines a CCP merge list of the chroma block unit, including CCP merge candidates, used to reconstruct chroma coding units prior to reconstructing the chroma block unit, and the on-the-fly CCP candidate of the chroma block unit. The method then reconstructs the chroma block unit based on the CCP merge list. An electronic device and a non-transitory machine-readable medium of an electronic device using such a method are also provided.

### CROSS-REFERENCE TO RELATED APPLICATION(S)

The present disclosure claims the benefit of and priority to U.S. Provisional Patent Application Ser. No. 63/699,780, filed on Sep. 26, 2024, entitled “ON INTRA TEMPLATE MATCHING AND CHROMA PREDICTION,” the content of which is hereby incorporated herein fully by reference in its entirety for all purposes.

### FIELD

The present disclosure generally relates to video coding, and more specifically, to techniques for predicting a chroma block unit using a cross-component prediction (CCP) merge list of the chroma block unit, the CCP merge list including an on-the-fly CCP candidate, which is determined based on a guiding block vector of the chroma block unit.

### BACKGROUND

Cross-component prediction (CCP) mode is a chroma coding tool for video coding, in which, an encoder and/or a decoder may predict a chroma block of a current block based on a luma block of the current block by using a prediction model.

In addition, the encoder and/or the decoder may determine the prediction model of the chroma block inherited from one of neighboring blocks generated prior to the reconstruction of the chroma block. The neighboring blocks may have neighboring models. The neighboring models of the neighboring blocks, however, may be just multiple potential models, but not the most appropriate model. Thus, the neighboring models of the neighboring blocks may be inadequate to precisely and efficiently predict all of several chroma samples in the chroma block.

Thus, model refinement modes for deriving multiple on-the-fly models of the chroma block may be required for the encoder and/or the decoder to be able to precisely and efficiently predict and/or reconstruct the chroma block of the block unit.

### SUMMARY

The present disclosure is directed to a non-transitory machine-readable medium and an electronic device for predicting a chroma block unit by using a cross-component prediction (CCP) merge list, including an on-the-fly CCP candidate, determined based on a guiding block vector of the chroma block unit.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a chroma block location of a chroma block unit from an image frame of the video data; determine a guiding block vector for the chroma block unit; determine a guided reference block from the image frame based on the guiding block vector; derive a first cross-component prediction (CCP) filter based on multiple first neighboring samples, neighboring the guided reference block, as a first on-the-fly CCP candidate of the chroma block unit; determine a CCP merge list of the chroma block unit, the CCP merge list including multiple CCP merge candidates of the chroma block unit and the first on-the-fly CCP candidate of the chroma block unit, where the multiple CCP merge candidates of the chroma block unit are used to reconstruct multiple chroma coding units prior to reconstructing the chroma block unit; and reconstruct the chroma block unit based on the CCP merge list of the chroma block unit.

In an implementation of the first aspect of the present disclosure, the one or more computer-executable instructions, when executed by the at least one processor of the electronic device, further cause the electronic device to: determine a CCP merge index of the chroma block unit from the video data; and select a CCP prediction candidate from the CCP merge list of the chroma block unit by using the CCP merge index of the chroma block unit, where: reconstructing the chroma block unit based on the CCP merge list of the chroma block unit comprises reconstructing the chroma block unit based on the selected CCP prediction candidate, and when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and multiple luma guided samples that are included in the guided reference block.

In an implementation of the first aspect of the present disclosure, the one or more computer-executable instructions, when executed by the at least one processor of the electronic device, further cause the electronic device to: determine a luma collocated block from the image frame, the luma collocated block collocated with the chroma block unit and reconstructed by using the guiding block vector; determine a chroma guided block and a luma guided block, both of which being included in the guided reference block, where the luma guided block is indicated by the guiding block vector from the luma collocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the first aspect of the present disclosure, determining the guided reference block from the image frame based on the guiding block vector includes: determining, from the image frame, a first luma relocated block that is indicated by the guiding block vector, where: the guiding block vector starts from a luma collocated block, and the luma collocated block, collocated with the chroma block unit and included in the image frame, is reconstructed by using the guiding block vector; and when the first luma relocated block is reconstructed by using a first relocated block vector, determining the guided reference block from the image frame based on the first relocated block vector.

In an implementation of the first aspect of the present disclosure, the one or more computer-executable instructions, when executed by the at least one processor of the electronic device, further cause the electronic device to: determine a chroma guided block and a luma guided block, both of which being included in the guided reference block, where the luma guided block is indicated by the first relocated block vector from the first luma relocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the first aspect of the present disclosure, determining the guided reference block from the image frame based on the first relocated block vector includes: determining, from the image frame, a second luma relocated block that is indicated by the first luma relocated vector, the first luma relocated vector starting from the first luma relocated block; and when the second luma relocated block is reconstructed by using a second relocated block vector, determining the guided reference block from the image frame based on the second relocated block vector.

In an implementation of the first aspect of the present disclosure, when the image frame is one of a random-access picture, an all-intra picture, and a gradual decoder refresh picture, the first on-the-fly CCP candidate of the chroma block unit is allowed to be added to the CCP merge list of the chroma block unit.

In an implementation of the first aspect of the present disclosure, the one or more computer-executable instructions, when executed by the at least one processor of the electronic device, further cause the electronic device to: derive a second CCP filter based on multiple second neighboring samples, neighboring a luma relocated block, as a second on-the-fly CCP candidate of the chroma block unit, where the luma relocated block is indicated from the guided reference block by a relocated block vector of the guided reference block; and add the second on-the-fly CCP candidate of the chroma block unit into the CCP merge list of the chroma block unit, where the number of the on-the-fly CCP candidates of the chroma block unit in the CCP merge list of the chroma block unit is greater than one.

In a second aspect of the present disclosure, an electronic device for decoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a chroma block location of a chroma block unit from an image frame of the video data; determine a guiding block vector for the chroma block unit; determine a guided reference block from the image frame based on the guiding block vector; derive a first cross-component prediction (CCP) filter based on multiple first neighboring samples, neighboring the guided reference block, as a first on-the-fly CCP candidate of the chroma block unit; determine a CCP merge list of the chroma block unit, the CCP merge list including multiple CCP merge candidates of the chroma block unit and the first on-the-fly CCP candidate of the chroma block unit, where the multiple CCP merge candidates of the chroma block unit are used to reconstruct multiple chroma coding units prior to reconstructing the chroma block unit; and reconstruct the chroma block unit based on the CCP merge list of the chroma block unit.

In an implementation of the second aspect of the present disclosure, the one or more computer-executable instructions, when executed by the at least one processor of the electronic device, further cause the electronic device to: determine a CCP merge index of the chroma block unit from the video data; and select a CCP prediction candidate from the CCP merge list of the chroma block unit by using the CCP merge index of the chroma block unit, where: reconstructing the chroma block unit based on the CCP merge list of the chroma block unit comprises reconstructing the chroma block unit based on the selected CCP prediction candidate, and when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and multiple luma guided samples that is included in the guided reference block.

In an implementation of the second aspect of the present disclosure, the one or more computer-executable instructions, when executed by the at least one processor of the electronic device, further cause the electronic device to: determine a luma collocated block from the image frame, the luma collocated block collocated with the chroma block unit and reconstructed by using the guiding block vector; determine a chroma guided block and a luma guided block, both of which being included in the guided reference block, where the luma guided block is indicated by the guiding block vector from the luma collocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the second aspect of the present disclosure, determining the guided reference block from the image frame based on the guiding block vector includes: determining, from the image frame, a first luma relocated block that is indicated by the guiding block vector, where: the guiding block vector starts from a luma collocated block, and the luma collocated block, collocated with the chroma block unit and included in the image frame, is reconstructed by using the guiding block vector; and when the first luma relocated block is reconstructed by using a first relocated block vector, determining the guided reference block from the image frame based on the first relocated block vector.

In an implementation of the second aspect of the present disclosure, the one or more computer-executable instructions, when executed by the at least one processor of the electronic device, further cause the electronic device to: determine a chroma guided block and a luma guided block, both of which being included in the guided reference block, where the luma guided block is indicated by the first relocated block vector from the first luma relocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the second aspect of the present disclosure, determining the guided reference block from the image frame based on the first relocated block vector includes: determining, from the image frame, a second luma relocated block that is indicated by the first luma relocated vector, the first luma relocated vector starting from the first luma relocated block; and when the second luma relocated block is reconstructed by using a second relocated block vector, determining the guided reference block from the image frame based on the second relocated block vector.

In an implementation of the second aspect of the present disclosure, when the image frame is one of a random-access picture, an all-intra picture, and a gradual decoder refresh picture, the first on-the-fly CCP candidate of the chroma block unit is allowed to be added to the CCP merge list of the chroma block unit.

In an implementation of the second aspect of the present disclosure, the one or more computer-executable instructions, when executed by the at least one processor of the electronic device, further cause the electronic device to: derive a second CCP filter based on multiple second neighboring samples, neighboring a luma relocated block, as a second on-the-fly CCP candidate of the chroma block unit, where the luma relocated block is indicated from the guided reference block by a relocated block vector of the guided reference block; and add the second on-the-fly CCP candidate of the chroma block unit into the CCP merge list of the chroma block unit, where the number of the on-the-fly CCP candidates of the chroma block unit in the CCP merge list of the chroma block unit is greater than one.

In a third aspect of the present disclosure, an electronic device for encoding video data is provided. The electronic device includes at least one processor and at least one non-transitory computer-readable medium that is coupled to the at least one processor. The at least one non-transitory computer-readable medium stores one or more computer-executable instructions that, when executed by the at least one processor, cause the electronic device to: receive the video data; determine a chroma block location of a chroma block unit from an image frame of the video data; determine a guiding block vector for the chroma block unit; determine a guided reference block from the image frame based on the guiding block vector; derive a first cross-component prediction (CCP) filter based on multiple first neighboring samples, neighboring the guided reference block, as a first on-the-fly CCP candidate of the chroma block unit; determine a CCP merge list of the chroma block unit, the CCP merge list including multiple CCP merge candidates of the chroma block unit and the first on-the-fly CCP candidate of the chroma block unit, where the multiple CCP merge candidates of the chroma block unit are used to reconstruct multiple chroma coding units prior to reconstructing the chroma block unit; and reconstruct the chroma block unit based on the CCP merge list of the chroma block unit.

In an implementation of the third aspect of the present disclosure, the one or more computer-executable instructions, when executed by the at least one processor of the electronic device, further cause the electronic device to: determine a CCP merge index of the chroma block unit from the video data; and select a CCP prediction candidate from the CCP merge list of the chroma block unit by using the CCP merge index of the chroma block unit, where: reconstructing the chroma block unit based on the CCP merge list of the chroma block unit comprises reconstructing the chroma block unit based on the selected CCP prediction candidate, and when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and multiple luma guided samples that is included in the guided reference block.

In an implementation of the third aspect of the present disclosure, the one or more computer-executable instructions, when executed by the at least one processor of the electronic device, further cause the electronic device to: determine a luma collocated block from the image frame, the luma collocated block collocated with the chroma block unit and reconstructed by using the guiding block vector; determine a chroma guided block and a luma guided block, both of which being included in the guided reference block, where the luma guided block is indicated by the guiding block vector from the luma collocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the third aspect of the present disclosure, determining the guided reference block from the image frame based on the guiding block vector includes: determining, from the image frame, a first luma relocated block that is indicated by the guiding block vector, where: the guiding block vector starts from a luma collocated block, and the luma collocated block, collocated with the chroma block unit and included in the image frame, is reconstructed by using the guiding block vector; and when the first luma relocated block is reconstructed by using a first relocated block vector, determining the guided reference block from the image frame based on the first relocated block vector.

In an implementation of the third aspect of the present disclosure, the one or more computer-executable instructions, when executed by the at least one processor of the electronic device, further cause the electronic device to: determine a chroma guided block and a luma guided block, both of which being included in the guided reference block, where the luma guided block is indicated by the first relocated block vector from the first luma relocated block; determine multiple chroma neighboring samples in a chroma neighboring region, neighboring the chroma guided block; and determine multiple luma neighboring samples in a luma neighboring region, neighboring the luma guided block, where the multiple chroma neighboring samples and the multiple luma neighboring samples are included in the multiple first neighboring samples.

In an implementation of the third aspect of the present disclosure, determining the guided reference block from the image frame based on the first relocated block vector includes: determining, from the image frame, a second luma relocated block that is indicated by the first luma relocated vector, the first luma relocated vector starting from the first luma relocated block; and when the second luma relocated block is reconstructed by using a second relocated block vector, determining the guided reference block from the image frame based on the second relocated block vector.

In an implementation of the third aspect of the present disclosure, when the image frame is one of a random-access picture, an all-intra picture, and a gradual decoder refresh picture, the first on-the-fly CCP candidate of the chroma block unit is allowed to be added to the CCP merge list of the chroma block unit.

In an implementation of the third aspect of the present disclosure, the one or more computer-executable instructions, when executed by the at least one processor of the electronic device, further cause the electronic device to: derive a second CCP filter based on multiple second neighboring samples, neighboring a luma relocated block, as a second on-the-fly CCP candidate of the chroma block unit, where the luma relocated block is indicated from the guided reference block by a relocated block vector of the guided reference block; and add the second on-the-fly CCP candidate of the chroma block unit into the CCP merge list of the chroma block unit, where the number of the on-the-fly CCP candidates of the chroma block unit in the CCP merge list of the chroma block unit is greater than one.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A-4C are schematic diagrams illustrating different luma guided blocks that are indicated by the guiding block vectors having the same magnitude and starting from different guiding start positions, in accordance with one or more example implementations of this disclosure.

FIG. 5 is a schematic diagram illustrating multiple luma relocated blocks that are indicated by multiple relocated block vectors and that are in different relocated levels, in accordance with one or more example implementations of this disclosure.

FIG. 6 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on at least one computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium or a non-transitory machine-readable medium.

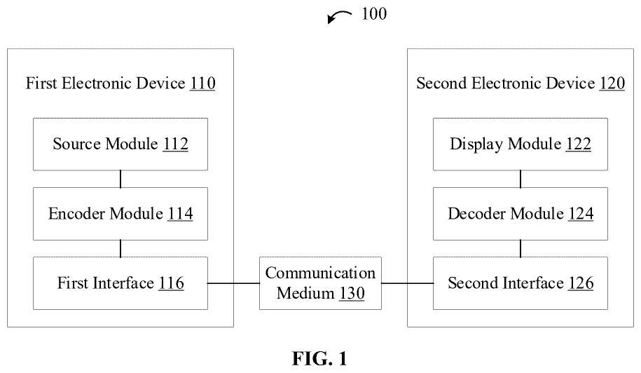

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and/or the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

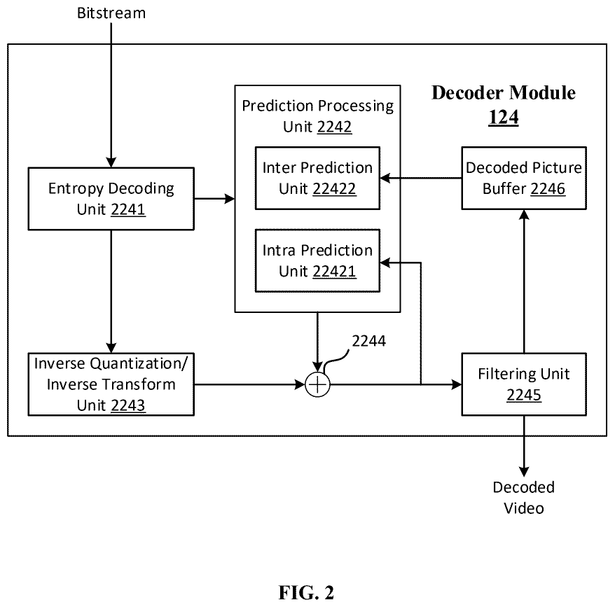

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames based on the partition information.

Each of the image frames may be divided into at least one image block based on the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

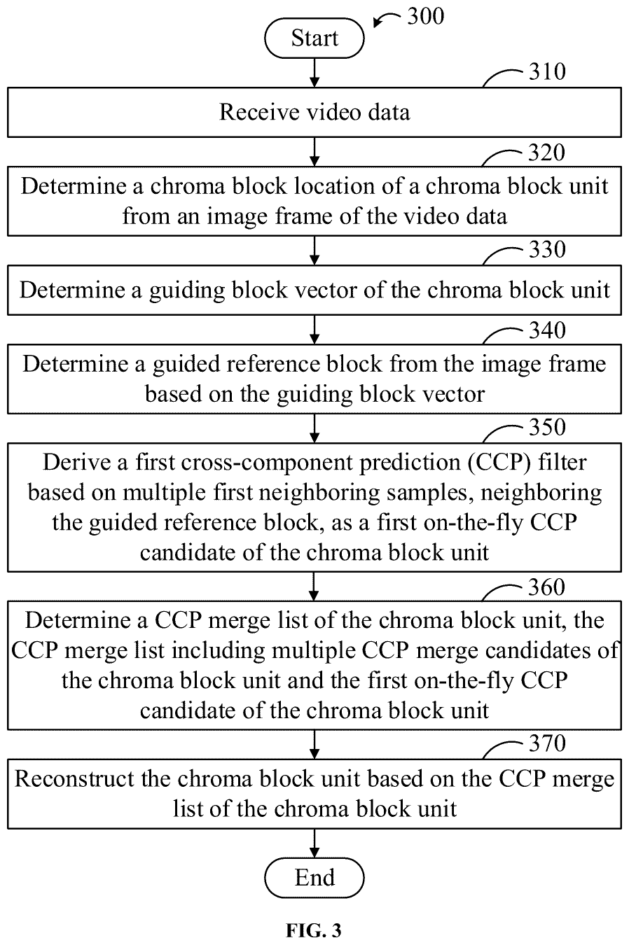

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

With reference to FIG. 3, at block 310, the method/process 300 may start by receiving (e.g., via the decoder module 124, as shown in FIG. 2) the video data. The video data received by the decoder module 124 may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a chroma block location of a chroma block unit from an image frame of the video data.

With reference to FIGS. 1 and 2, the decoder module 124 may determine the image frames included in the bitstream when the video data, received by the decoder module 124, includes the bitstream. The current frame may be one of the image frames, determined based on the bitstream. The decoder module 124 may further divide the current frame to determine the chroma block unit, according to the partition indications in the bitstream. In some implementations, the decoder module 124 may divide the current frame to generate multiple CTUs, and may further divide a current CTU, included in the CTUs, to generate multiple divided blocks and to determine the chroma block unit from the divided blocks, according to the partition indications (e.g., based on any video coding standard).

In some other implementations, the decoder module 124 may divide the current frame to generate multiple slices or multiple tiles, and further divide a current slice or a current tile, included in the slices or the tiles, to generate multiple CTUs. In addition, the decoder module 124 may further divide a current CTU, included in the CTUs, to generate multiple divided blocks and to determine the chroma block unit from the divided blocks, based on the partition indications. Furthermore, the decoder module 124 may determine a luma collocated block from the current frame. The luma collocated block may be collocated with the chroma block unit.

In some implementations, only one luma collocated unit may be collocated with the chroma block unit and regarded, as the luma collocated block, when the chroma block unit is included in a single-tree block unit that is determined from the current frame. In some other implementations, at least one luma collocated unit may be covered by the luma collocated block, that is collocated with the chroma block unit, when the chroma block unit is included in a dual-tree block. The dual-tree block may be determined from the current frame.

The luma collocated block may be reconstructed prior to the reconstruction of the chroma block unit. Thus, a luma block vector may be determined for predicting and reconstructing a portion of, or the entirety of, the luma collocated block prior to the reconstruction of the chroma block unit.

The size of the chroma block unit may be Wb×Hb. The size of the luma collocated block may be determined based on the size of the chroma block unit and a scaling facture SF. The scaling factor SF, including a width scaling factor SubWidthC and a height scaling factor SubHeightC, may be determined based on a video format. Thus, the size of the luma collocated block may be (Wb×SubWidthC)×(Hb×SubHeightC). In some implementations, each of the Wb, Hb, SubWidthC, and SubHeightC may be a positive integer (e.g., one, two, etc.) that may be the same as, or different from, the other ones.

In some implementations, if the video format is YUV422, the scaling factor may further include the width scaling factor SubWidthC of two and the height scaling factor SubHeightC of one. Thus, the size of the luma collocated block may be 2Wb×Hb. In some other implementations, if the video format is YUV420, the scaling factor may further include the width scaling factor SubWidthC of two and the height scaling factor SubHeightC of two. Thus, the size of the luma collocated block may be 2Wb×2Hb.

In addition, a luma block location of the luma collocated block may be represented by (xCb, yCb) specifying a top-left luma sample of the luma collocated block relative to a top-left luma sample of the current frame. The chroma block location of the chroma block unit may be represented by (xCb/SubWidthC, yCb/SubHeightC) specifying a top-left chroma sample of the chroma block unit relative to a top-left chroma sample of the current frame.

Referring back to FIG. 3, at block 330, the decoder module 124 may determine a guiding block vector for the chroma block unit.

With reference to FIGS. 1 and 2, the decoder module 124 may determine the guiding block vector based on a luma reference vector of a luma reference unit, covered by the luma collocated block. In some implementations, the luma reference vector of the luma reference unit may be generated by using an intra block copy (IBC) mode, or an intra template matching prediction (intraTMP) mode of a video coding standard, including a Versatile Video Coding (VVC) standard.

The at least one luma collocated unit, covered by the luma collocated block, may be reconstructed prior to the reconstruction of the chroma block unit. The luma reference unit, having the luma reference vector, may be included in the at least one luma collocated unit. The luma reference unit may cover at least one of multiple luma reference positions of the luma collocated block. The luma reference positions may include a first reference position, located at a top-right corner of the luma collocated block, a second reference position, located at a top-left corner of the luma collocated block, a third reference position, located at a center position of the luma collocated block, a fourth reference position, located at a bottom-left corner of the luma collocated block, and a fifth reference position, located at a bottom-right corner of the luma collocated block.

When a specific one of the at least one luma collocated unit, which covers at least one of the luma reference positions, is predicted based on a luma block vector, the specific luma collocated unit may be regarded, as the luma reference unit. In addition, the luma block vector of the specific luma collocated unit may be regarded, as the luma reference vector of the luma reference unit. In some implementations, the number of luma reference vectors, determined based on the at least one luma collocated unit, may be equal to, or greater than, one. For example, there may be three different luma reference units covering, respectively, one or more of the luma reference positions, and may be predicted based on a luma block vector. Thus, the number of luma reference vectors may be equal to three.

When the guiding block vector is determined based on the luma reference vector of the luma reference unit, the guiding block vector may be identical to the luma reference vector of the luma reference unit, covered by the luma collocated block. Thus, the luma collocated block may be reconstructed by using the guiding block vector, since a portion of the luma collocated block that overlaps the luma reference unit is reconstructed using the guiding block vector.

Referring back to FIG. 3, at block 340, the decoder module 124 may determine a guided reference block from the image frame based on the guiding block vector.

The guided reference block may include a chroma guided block and a luma guided block. Thus, with reference to FIGS. 1 and 2, the decoder module 124 may determine the chroma guided block and the luma guided block, both of which may be included in the guided reference block.

In some implementations, the luma guided block of the guided reference block may be indicated from the luma collocated block by the guiding block vector. Thus, the guided reference block may be determined based on the luma collocated block and the guiding block vector. The luma guided block may be indicated by the guiding block vector, that starts from one of multiple guiding start positions of the luma collocated block to one of multiple guiding end positions, for determining the luma guided block.

The guiding start positions may be predefined in the first electronic device 110 and the second electronic device 120. The number of guiding start positions may be equal to, or greater than, one. For example, when the number of guiding start positions is equal to five, the guiding start positions may include a first guiding start position C1, located at the center position of the luma collocated block, a second guiding start position AL1, located at the top-left corner of the luma collocated block, a third guiding start position AR1, located at the top-right corner of the luma collocated block, a fourth guiding start position BL1, located at the bottom-left corner of the luma collocated block, and a fifth guiding start position BR1, located at a bottom-right corner of the luma collocated block. For example, when the coordinates of the luma collocated block in the image frame are (xCb, yCb), the coordinates of the five guiding start positions may, respectively, be C1 (xCb+((Wb×SubWidthC−1)/2), yCb+((Hb×SubHeightC−1)/2)), AL1 (xCb, yCb), AR1 (xCb+Wb×SubWidthC−1, yCb), BL1 (xCb, yCb+Hb×SubHeightC−1), and BR1 (xCb+Wb×SubWidthC−1, yCb+Hb×SubHeightC−1). In some other implementations, the coordinates of the five guiding start positions may, respectively, be C1 (xCb+(Wb×SubWidthC/2), yCb+(Hb×SubHeightC/2)), AL1 (xCb, yCb), AR1 (xCb+Wb×SubWidthC−1, yCb), BL1 (xCb, yCb+Hb×SubHeightC−1), and BR1 (xCb+Wb×SubWidthC−1, yCb+Hb×SubHeightC−1).

A search order of the guiding start positions for determining the luma guided block may be predefined in the first electronic device 110 and the second electronic device 120. For example, when the number of guiding start positions is equal to five, the five guiding start positions for determining the luma guided block may be sequentially arranged/ordered from the first guiding start position to the fifth guiding start position. In other words, the search order of the guiding start positions for determining the luma guided block may be sequentially arranged, as Cl, AL1, AR1, BL1, and BR1.

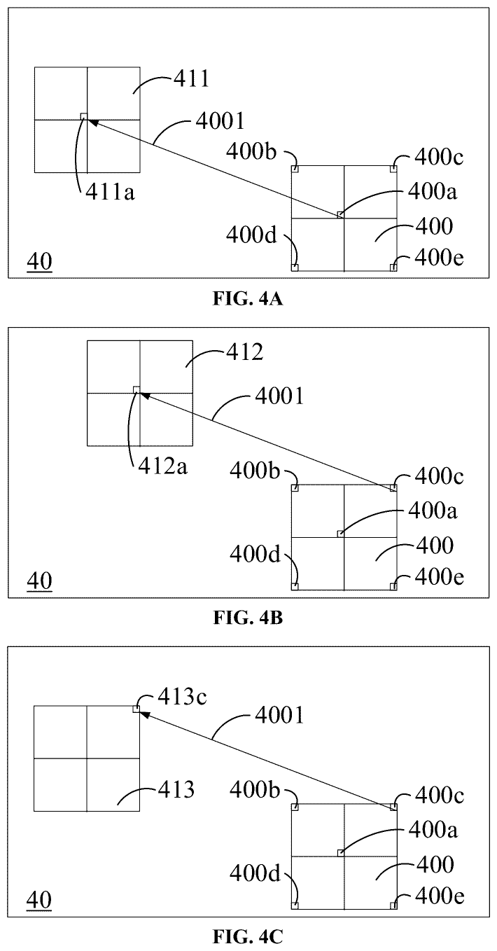

FIGS. 4A-4C are schematic diagrams illustrating different luma guided blocks that are indicated by the guiding block vectors having the same magnitude and starting from different guiding start positions, in accordance with one or more example implementations of this disclosure.

FIG. 4A illustrates the luma guided block 411 that is indicated by the guiding block vector 4001, that starts from the guiding start position 400a of the luma collocated block 400 to the guiding end position 411a. In FIG. 4A, the guiding block vector 4001 may be the guiding block vector that indicates the luma guided block 411, included in an image frame 40. Thus, both the luma collocated block 400 and the luma guided block 411 may be included in the image frame 40.

The luma collocated block 400 may cover the first guiding start position 400a, the second guiding start position 400b, the third guiding start position 400c, the fourth guiding start position 400d, and the fifth guiding start position 400e. In order to determine the luma guided block 411, the decoder module 124 may select one of the guiding start positions 400a-400e, as a starting point of the guiding block vector 4001. For example, in FIG. 4A, for determining the luma guided block 411, the starting point of the guiding block vector 4001 may be the first guiding start position 400a.

The guiding end position may be included in the luma guided block. A size of the luma guided block may be identical to the size (Wb×SubWidthC)×(Hb×SubHeightC) of the luma collocated block. The location of the luma guided block may be determined based on the size (Wb×SubWidthC)×(Hb×SubHeightC) of the luma collocated block and the spatial relationship between the guiding end position and the luma guided block. A method for determining the spatial relationship between the guiding end position and the luma guided block may be predefined in the first electronic device 110 and/or the second electronic device 120.

In some implementations, the guiding end position may be predefined, as a center position of the luma guided block. Thus, the guiding end position may be first determined by using the guiding block vector and the guiding start position of the luma collocated block. The luma guided block may then be determined by uniformly extending a block from the guiding end position in different directions to generate an intermediate block that has the same size, as the luma collocated block. The intermediate block, covering the guiding end position, which is located at a center position of the intermediate block, may be regarded, as the luma guided block. For example, the guiding end position 411a may be first determined based on the guiding block vector 4001 and the guiding start position 400a of the luma collocated block 400. Since the guiding end position 411a is predefined, as to be located at the center position of the luma guided block 411, the decoder module 124 may uniformly extend a block from the guiding end position 411a in different directions to generate the luma guided block 411. In addition, the luma guided block 411 may have the same size, as the luma collocated block 400.

FIG. 4B illustrates the luma guided block 412 that is indicated by the guiding block vector 4001 that starts from the guiding start position 400c of the luma collocated block 400 to the guiding end position 412a. In FIG. 4B, the guiding block vector 4001 may be the guiding block vector that indicates the luma guided block 412, included in the image frame 40. Thus, both the luma collocated block 400 and the luma guided block 412 may be included in the image frame 40.

In order to determine the luma guided block 412, the decoder module 124 may select one of the guiding start positions 400a-400e, as the starting point of the guiding block vector 4001. For example, in FIG. 4B, the starting point of the guiding block vector 4001 may be the third guiding start position 400c, for determining the luma guided block 412. The guiding end position 412a may be first determined based on the guiding block vector 4001 and the guiding start position 400c of the luma collocated block 400. Since the guiding end position 412a is predefined, as to be located at the center position of the luma guided block 412, the decoder module 124 may uniformly extend a block from the guiding end position 412a in different directions to generate the luma guided block 412. In addition, the luma guided block 412 may have the same size, as the luma collocated block 400.

FIG. 4C illustrates the luma guided block 413 that is indicated by the guiding block vector 4001 that starts from the guiding start position 400c of the luma collocated block 400 to the guiding end position 413c. In FIG. 4C, the guiding block vector 4001 may be the guiding block vector that indicates the luma guided block 413, included in the image frame 40. Thus, both the luma collocated block 400 and the luma guided block 413 may be included in the image frame 40.

In order to determine the luma guided block 413, the decoder module 124 may select one of the guiding start positions 400a-400e, as the starting point of the guiding block vector 4001. For example, in FIG. 4C, for determining the luma guided block 413, the starting point of the guiding block vector 4001 may be the third guiding start position 400c. The guiding end position 413c may be first determined based on the guiding block vector 4001 and the guiding start position 400c of the luma collocated block 400. Since the spatial relationship between the guiding end position and the luma guided block 413 may be identical to the spatial relationship between the guiding start position and the luma collocated block 400, the decoder module 124 may extend a block from the guiding end position 413c based on the spatial relationship between the guiding end position and the luma guided block 413 to generate the luma guided block 413. In FIG. 4C, the decoder module 124 may extend the block from the guiding end position 413c in the bottom-left direction to generate the luma guided block 413 that has the same size, as the luma collocated block 400. Thus, guiding end position 413c may be located at the top-right corner of the luma guided block 413.

In some other implementations, the luma guided block of the guided reference block may be indicated by a first relocated block vector of a first luma relocated block from the first luma relocated block. The first luma relocated block may be reconstructed by using the first relocated block vector. Thus, when the first luma relocated block is reconstructed by using the first relocated block vector, the decoder module 124 may determine the guided reference block from the image frame based on the first relocated block vector.

The first luma relocated block may be determined from the image frame based on the luma collocated block and the guiding block vector. The first luma relocated block may be indicated by the guiding block vector, that starts from one of the guiding start positions of the luma collocated block to one of the guiding end positions, for determining the first luma relocated block.

A search order of the guiding start positions for determining the first luma relocated block may be predefined in the first electronic device 110 and the second electronic device 120. For example, when the number of guiding start positions is equal to five, the five guiding start positions for determining the first luma relocated block may be sequentially ordered from the first guiding start position to the fifth guiding start position. In other words, the search order of the guiding start positions for determining the first luma relocated block may be sequentially arranged, as Cl, AL1, AR1, BL1, and BR1.

The number of guiding start positions and the number of guiding end positions may be equal to, or greater than, one. Thus, the decoder module 124 may determine at least one first luma relocated candidate block, each indicated by the guiding block vector, for determining the first luma relocated block. Each of the at least one first luma relocated candidate block may be overlapped with at least one first luma relocated candidate unit.

The first relocated block vector of the first luma relocated block may be determined based on a first relocated reference vector of a first luma relocated unit, covered by a specific one of the at least one first luma relocated candidate block. In some implementations, the first relocated reference vector of the first luma relocated unit may be generated using the IBC mode, or the intraTMP mode of the video coding standard.

The first luma relocated unit, covered by the specific first luma relocated candidate block, may be reconstructed prior to the reconstruction of the chroma block unit. The first luma relocated unit, having the first relocated reference vector, may be included in the at least one first luma relocated candidate unit of the specific first luma relocated candidate block.

The first luma relocated unit may cover at least one of multiple luma relocated reference positions of the specific first luma relocated candidate block. The luma relocated reference positions may include a first luma relocated reference position, located at a top-right corner of the specific first luma relocated candidate block, a second luma relocated reference position, located at a top-left corner of the specific first luma relocated candidate block, a third luma relocated reference position, located at a center position of the specific first luma relocated candidate block, a fourth luma relocated reference position, located at a bottom-left corner of the specific first luma relocated candidate block, and a fifth luma relocated reference position, located at a bottom-right corner of the specific first luma relocated candidate block.

When a specific one of the at least one first luma relocated candidate unit, which covers at least one of the luma relocated reference positions, is predicted based on a first relocated candidate vector, the specific first luma relocated candidate unit may be regarded, as the first luma relocated unit. In addition, the first relocated candidate vector of the specific first luma relocated candidate unit may be regarded, as the first relocated block vector of the first luma relocated unit. In some implementations, the number of first relocated block vectors, determined based on the at least one first luma relocated candidate unit, may be equal to, or greater than, one.

The first relocated block vector may be used to predicted the first luma relocated unit, covered by the first luma relocated block. Thus, the first luma relocated block may be reconstructed by using the first relocated block vector, since a portion of the first luma relocated block that overlaps with the first luma relocated unit is reconstructed using the first relocated block vector.

The luma guided block of the guided reference block may be determined from the image frame based on the first luma relocated block and the first relocated block vector. The luma guided block of the guided reference block may be indicated by the first relocated block vector, that starts from one of multiple relocated start positions of the first luma relocated block to one of multiple relocated end positions, for determining the luma guided block of the guided reference block.

A search order of the relocated start positions for determining the luma guided block of the guided reference block may be predefined in the first electronic device 110 and the second electronic device 120. In addition, the spatial relationship between the relocated start positions and the first luma relocated block may be identical to the spatial relationship between the guiding start positions and the luma collocated block.

In some other implementations, the luma guided block of the guided reference block may be indicated by a second relocated block vector of a second luma relocated block from the second luma relocated block. The second luma relocated block may be reconstructed by using the second relocated block vector. Thus, when the second luma relocated block is reconstructed by using the second relocated block vector, the decoder module 124 may determine the guided reference block from the image frame based on the second relocated block vector.

The second luma relocated block may be determined from the image frame based on the first luma relocated block and the first luma relocated vector. The second luma relocated block may be indicated by the first luma relocated vector, that starts from one of the relocated start positions of the first luma relocated block to one of the relocated end positions, for determining the second luma relocated block. The search scheme for searching for the second luma relocated block based on the first luma relocated vector may be identical to, similar to, or corresponding to that for searching for the first luma relocated block based on the guiding block vector.

In some other implementations, the luma guided block of the guided reference block may be indicated by a (N+1)-th relocated block vector of a (N+1)-th luma relocated block from the (N+1)-th luma relocated block. The (N+1)-th luma relocated block may be reconstructed by using the (N+1)-th relocated block vector. Thus, when the (N+1)-th luma relocated block is reconstructed by using the (N+1)-th relocated block vector, the decoder module 124 may determine the guided reference block from the image frame based on the (N+1)-th relocated block vector. The number (N+1) may be a relocated level of the (N+1)-th chroma relocated block. In some implementations, the number N may be a positive integer, equal to, or greater than, one.

The (N+1)-th luma relocated block may be determined from the image frame based on an N-th luma relocated block and an N-th luma relocated vector. The (N+1)-th luma relocated block may be indicated by the N-th luma relocated vector, that starts from one of multiple relocated start positions of the N-th luma relocated block to one of multiple relocated end positions, for determining the (N+1)-th luma relocated block. The search scheme for searching for the (N+1)-th luma relocated block based on the N-th luma relocated vector may be identical to, similar to, or corresponding to that for searching for the second luma relocated block based on the first luma relocated vector.

In some implementations, the relocated level may be equal to, or less than, a relocated level threshold. With reference to FIGS. 1 and 2, the decoder module 124 may stop determining the luma relocated block when the relocated level of the chroma relocated block is equal to the relocated level threshold. In some implementations, the relocated level threshold may be predefined in the first electronic device 110 and the second electronic device 120. In some implementations, the relocated level threshold may be equal to two, three, or four.

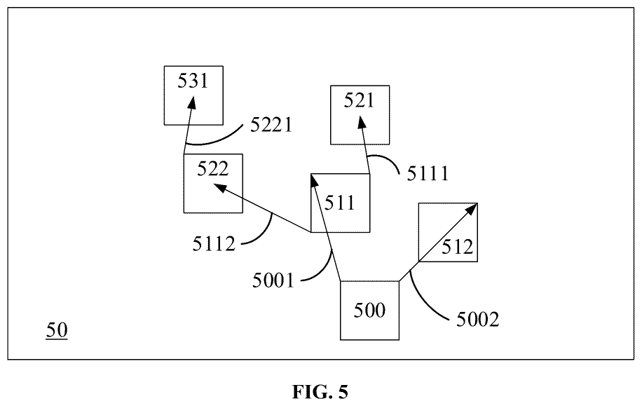

FIG. 5 is a schematic diagram illustrating multiple luma relocated blocks that are indicated by multiple relocated block vectors and that are in different relocated levels, in accordance with one or more example implementations of this disclosure. In FIG. 5, the relocated level threshold may be equal to, or greater than, three.

The decoder module 124 may search for the guiding block vectors for the luma collocated block 500. In FIG. 5, the decoder module 124 may determine two different guiding block vectors 5001 and 5002 for the luma collocated block 500.

The first luma relocated block 511 may be indicated by the guiding block vector 5001 that starts from the top-left corner of the luma collocated block 500 to the top-left corner of the first luma relocated block 511. The first luma relocated block 511 may be regarded, as the luma guided block. The decoder module 124 may then derive the first CCP filter for the first on-the-fly CCP candidate based on the first neighboring samples of the first luma relocated block 511. In addition, the decoder module 124 may also search for a first relocated block vector based on the luma relocated reference positions in the first luma relocated block 511. In FIG. 5, the decoder module 124 may determine two first relocated block vectors 5111 and 5112 for the first luma relocated block 511.

The second luma relocated block 521 may be indicated by the first relocated block vector 5111 that starts from the top-right corner of the first luma relocated block 511 to the center point of the second luma relocated block 521. The second luma relocated block 521 may be regarded, as the luma guided block. The decoder module 124 may then derive the second CCP filter for the second on-the-fly CCP candidate based on multiple second neighboring samples of the second luma relocated block 521. In addition, the decoder module 124 may also search for a second relocated block vector based on the luma relocated reference positions in the second luma relocated block 521. In FIG. 5, the decoder module 124 may determine no second relocated block vector based on the luma relocated reference positions of the second luma relocated block 521.

The second luma relocated block 522 may be indicated by the first relocated block vector 5112 that starts from the bottom-left corner of the first luma relocated block 511 to the center point of the second luma relocated block 522. The second luma relocated block 522 may be regarded, as the luma guided block. The decoder module 124 may then derive the second CCP filter for the second on-the-fly CCP candidate based on multiple second neighboring samples of the second luma relocated block 522. In addition, the decoder module 124 may also search for a second relocated block vector based on the luma relocated reference positions in the second luma relocated block 522. In FIG. 5, the decoder module 124 may determine one second relocated block vector 5221 for the second luma relocated block 522.

The third luma relocated block 531 may be indicated by the second relocated block vector 5221 that starts from the top-left corner of the second luma relocated block 522 to the center point of the third luma relocated block 531. The third luma relocated block 531 may be regarded, as the luma guided block. The decoder module 124 may then derive the second CCP filter for the second on-the-fly CCP candidate based on multiple second neighboring samples of the third luma relocated block 531. In some implementations, the decoder module 124 may also search for a third relocated block vector based on the luma relocated reference positions in the third luma relocated block 531. In FIG. 5, the decoder module 124 may determine no third relocated block vector based on the luma relocated reference positions of the third luma relocated block 351. In some other implementations, the decoder module 124 may not further search for the third relocated block vector when the relocated level threshold is equal to three.

In some implementations, after a search loop of deriving the CCP filers based on the top-left corner of the luma collocated block 500 ends, the decoder module 124 may start to derive the CCP filters based on the top-right corner of the luma collocated block 500.

The first luma relocated block 512 may be indicated by the guiding block vector 5002 that starts from the top-right corner of the luma collocated block 500 to the top-right corner of the first luma relocated block 512. The first luma relocated block 512 may be regarded, as the luma guided block. The decoder module 124 may then derive the second CCP filter for the second on-the-fly CCP candidate based on multiple second neighboring samples of the first luma relocated block 512. In addition, the decoder module 124 may also search for the first relocated block vector based on the luma relocated reference positions in the first luma relocated block 512. In FIG. 5, the decoder module 124 may determine no first relocated block vector based on the luma relocated reference positions of the first luma relocated block 512.

Referring back to FIG. 3, at block 350, the decoder module 124 may derive a first cross-component prediction (CCP) filter based on multiple first neighboring samples, neighboring the guided reference block, as a first on-the-fly CCP candidate of the chroma block unit.

With reference to FIGS. 1 and 2, the decoder module 124 may determine a block neighboring region of the guided reference block. The block neighboring region may include the first neighboring samples. In addition, the block neighboring region may include a chroma neighboring region, that neighbors the chroma guided block of the guided reference block, and a luma neighboring region, that neighbors the luma guided block of the guided reference block. The chroma neighboring region may include multiple chroma neighboring samples, neighboring the chroma guided block. The luma neighboring region may include multiple luma neighboring samples, neighboring the luma guided block. The chroma neighboring samples of the chroma neighboring region and the luma neighboring samples of the luma neighboring region may be included in the first neighboring samples of the block neighboring region.

In some implementations, the decoder module 124 may derive the first CCP filter, based on the chroma neighboring samples and the luma neighboring samples, using a down-sampling filter or a sub-sampling filter. Multiple luma scaled samples of the luma neighboring region may be derived, based on the scaling factor, using the down-sampling filter or the sub-sampling filter. The number of chroma neighboring samples of the chroma neighboring region may be equal to the number of luma scaled samples of the luma neighboring region.

Thus, the first CCP filter may be derived based on the chroma neighboring samples of the chroma neighboring region and the luma scaled samples of the luma neighboring region. The scaling factor for the determination of the luma scaled samples may be identical to the scaling factor for the determination of the luma collocated block, collocated with the chroma block unit.

In some implementations, the first CCP filter may be generated by deriving multiple filter coefficients of a predefined chroma filter based on the luma scaled samples and the chroma neighboring samples. In some implementations, the predefined chroma filter may be derived in one of a cross-component linear model (CCLM) mode, a multi-model linear model (MMLM) mode, a convolutional cross-component model (CCCM) mode, a gradient and location based CCCM (GL-CCCM) mode, a block-vector guided CCCM (BVG-CCCM) mode, or a gradient linear model (GLM) mode.

In some implementations, the predefined chroma filter may include a quadratic equation. The quadratic equation may include Ns luma spatial sample terms, Np non-linear terms, and one bias term B. The number Ns may be a positive integer (e.g., 3, 4, 5, etc.). The number Np may also be a positive integer (e.g., 0, 1, 2, 3, 4, 5, etc.). In some implementations, the quadratic equation, including five luma spatial sample terms, five non-linear terms, and one bias term B, may be used in the BVG-CCCM mode. The five luma spatial sample terms may include a center sample C, a north sample N, a south sample S, a west sample W, and an east sample E. Thus, the predefined chroma filter may be shown, as in the following equation:

$$predChromaVal = c 0 \times C + c 1 \times N + c 2 \times S + c 3 \times E + c 4 \times W + c 5 \times P ( C ) + c 6 \times P ( N ) + c 7 \times P ( S ) + c 8 \times P ( E ) + c 9 \times P ( W ) + c 10 \times B ,$$

where the coefficients c0-c10 are eleven filter coefficients for the luma spatial sample terms C, N, S, W, and E, the non-linear terms, and the bias term B, and where predChromaVal may include a predicted chroma sample located at a sample position (x, y), relative to a top-left chroma sample of the chroma block unit 52. The non-linear term P(Q) may be equal to (Q×Q+midVal)>>bitDepth, and the bias term B may be equal to 2^{bitDepth-1} The parameter midVal and the bias term B may be set, as a middle luma value, and the parameter bitDepth may be a bit depth of the samples in the bitstream. For example, the bias term B may be set to 512 for 10 bits content.

In some implementations, the quadratic equation, including five luma spatial sample terms, one non-linear term, and one bias term B, may be used in the BVG-CCCM mode. The five luma spatial sample terms may include the center sample C, the north sample N, the south sample S, the west sample W, and the east sample E. Thus, the predefined chroma filter may be shown, as in the following equation:

$$predChromaVal = c 0 \times C + c 1 \times N + c 2 \times S + c 3 \times E + c 4 \times W + c 5 \times P ( C ) + c 6 \times B ,$$

where the coefficients c0-c6 are seven filter coefficients for the luma spatial sample terms C, N, S, W, and E, the non-linear terms, and the bias term B, and where predChromaVal may be a predicted chroma sample located at the sample position (x, y), relative to the top-left chroma sample of the chroma block unit 52.

The decoder module 124 may derive the filter coefficients of the predefined chroma filter to determine the first CCP filter based on the luma scaled samples and the chroma neighboring samples. In some implementations, the filter coefficients of the predefined chroma filter may be derived using the LDL decomposition. In some implementations, the filter coefficients of the predefined chroma filter may be derived using the gaussian elimination. In some implementations, the filter coefficients of the predefined chroma filter may be derived by the same method as in the BVG-CCCM of the video coding standard.

Since the first CCP filter is derived based on the chroma neighboring samples and the luma scaled samples during the reconstruction of the chroma block unit, the first CCP filter may be determined, as the first on-the-fly CCP candidate of the chroma block unit. Furthermore, the decoder module 124 may determine a second on-the-fly CCP candidate of the chroma block unit by deriving a second CCP filter during the reconstruction of the chroma block unit. The second CCP filter may be determined based on the second neighboring samples, that neighbor one of multiple luma relocated blocks, such as a third luma relocated block. The third luma relocated block may be indicated from the guided reference block by a relocated block vector of the guided reference block.

In some implementations, the third luma relocated block may be determined from the image frame based on the luma collocated block and the guiding block vector. The third luma relocated block may be indicated by the guiding block vector, that starts from one of the guiding start positions of the luma collocated block to one of the guiding end positions, for determining the third luma relocated block. A combination of the specific guiding start position and the specific guiding end position for determining the first luma relocated block may be different from that for determining the third luma relocated block.

In some other implementations, the third luma relocated block may be determined from the image frame based on the first luma relocated block and the first relocated block vector. The third luma relocated block may be indicated by the first relocated block vector, that starts from one of the relocated start positions of the first luma relocated block to one of the relocated end positions, for determining the third luma relocated block. A combination of the specific relocated start position and the relocated end position for determining the second luma relocated block may be different from that for determining the third luma relocated block.

In some other implementations, the third luma relocated block may be determined from the image frame based on a third relocated block vector of the first luma relocated block and the first luma relocated block. The third luma relocated block may be indicated by the third relocated block vector, that starts from one of the relocated start positions of the first luma relocated block to one of the relocated end positions, for determining the third luma relocated block. The third relocated block vector may be used to reconstruct a second luma relocated unit, which is different from the first luma relocated unit and is also covered by first luma relocated block.

In some other implementations, the third luma relocated block may be determined from the image frame based on a fourth relocated block vector of a fourth luma relocated block and the second luma relocated block. The fourth luma relocated block may be indicated by the second relocated block vector, that starts from one of multiple relocated start positions of the second luma relocated block to one of multiple relocated end positions, for determining the fourth luma relocated block.

Referring back to FIG. 3, at block 360, the decoder module 124 may determine a CCP merge list of the chroma block unit, the CCP merge list including multiple CCP merge candidates of the chroma block unit and the first on-the-fly CCP candidate of the chroma block unit.

With reference to FIGS. 1 and 2, the decoder module 124 may determine the CCP merge candidates of the chroma block unit to construct the CCP merge list of the chroma block unit. Multiple previous CCP parameters in the CCP merge candidates of the chroma block unit may be used to reconstruct multiple chroma coding units prior to reconstructing the chroma block unit.

Each of the CCP merge candidates of the chroma block unit may be determined according to one of multiple predefined CCP merge candidates. In some implementations, the predefined CCP merge candidates may include at least one of multiple spatial adjacent CCP merge candidates, multiple spatial non-adjacent CCP merge candidates, multiple temporal CCP merge candidates, multiple history-based CCP merge candidates, multiple shifted temporal CCP merge candidates, or multiple default CCP merge candidates. Additional candidate types may be added, or fewer candidate types may be utilized, without departing from the scope of the present disclosure.

In some implementations, the spatial adjacent CCP merge candidates may indicate multiple spatial adjacent CCP candidate blocks. Each of the spatial adjacent CCP candidate blocks may cover at least one of multiple predefined spatial adjacent CCP positions. When one of the spatial adjacent CCP candidate blocks is predicted using a CCP filter in a CCP mode, the one of the spatial adjacent CCP candidate blocks may be selected, as one of multiple CCP-reconstructed blocks. Multiple previous CCP parameters of the CCP filter used to predict the one of the spatial adjacent CCP candidate blocks may be selected to generate one of the CCP merge candidates included in the CPP merge list.

In some other implementations, the spatial non-adjacent CCP merge candidates may indicate multiple spatial non-adjacent CCP candidate blocks. Each of the spatial non-adjacent CCP candidate blocks may cover at least one of multiple predefined spatial non-adjacent CCP positions. When one of the spatial non-adjacent CCP candidate blocks is predicted using a CCP filter in the CCP mode, the one of the spatial non-adjacent CCP candidate blocks may be selected, as one of the CCP-reconstructed blocks. Multiple previous CCP parameters of the CCP filter used to predict the one of the spatial non-adjacent CCP candidate blocks may be selected to generate one of the CCP merge candidates included in the CPP merge list.

In some other implementations, the temporal CCP merge candidates may indicate multiple temporal CCP candidate blocks. Each of the temporal CCP candidate blocks may cover at least one of multiple predefined temporal CCP positions of a reference picture in multiple reference picture lists. The reference picture lists may include a first reference picture list L0 and a second reference picture list Li. When one of the temporal CCP candidate blocks is predicted using a CCP filter in the CCP mode, the one of the temporal CCP candidate blocks may be selected, as one of the CCP-reconstructed blocks. Multiple previous CCP parameters of the CCP filter used to predict the one of the temporal CCP candidate blocks may be selected to generate one of the CCP merge candidates included in the CPP merge list.

In some other implementations, multiple previous blocks reconstructed prior to the reconstruction of the chroma block unit may be reconstructed based on multiple reconstruction schemes. When one of the previous blocks is reconstructed using a specific one of the CCP filters in the CCP mode, the previous CCP parameters of the specific CPP filter used to predict the one of the previous blocks may be stored in a CCP table on a first-in-first-out (FIFO) basis. The size of the CCP table may be equal to Nt. In some implementations, Nt may be a positive integer, such as 6 or 12. Multiple previous CCP parameters of the CCP filter stored in the CCP table may be selected to generate one of the CCP merge candidates included in the CPP merge list.

The number of CCP merge candidates may be equal to Nc. In some implementations, the number Nc may be a positive integer, such as 6 or 12. With reference to FIGS. 1 and 2, when the decoder module 124 checks whether the spatial adjacent CCP merge candidates, the spatial non-adjacent CCP merge candidates, the temporal CCP merge candidates, the history-based CCP merge candidates, and the shifted temporal CCP merge candidates are allowable to be added to the CCP merge candidates of the chroma block unit, the decoder module 124 may also check whether the number of added CCP merge candidates of the chroma block unit may be equal to the number Nc. When the number of added CCP merge candidates of the chroma block unit is equal to the number Nc, the decoder module 124 may bypass checking and may stop adding the predefined CCP merge candidates to the CCP merge candidates.

In some implementations, after the decoder module 124 finishes checking on whether the spatial adjacent CCP merge candidates, the spatial non-adjacent CCP merge candidates, the temporal CCP merge candidates, the history-based CCP merge candidates, and the shifted temporal CCP merge candidates are allowable to be added to the CCP merge candidates of the chroma block unit, the number of added CCP merge candidates of the chroma block unit may still be less than the number Nc. Thus, the decoder module 124 may add at least one of the default CCP merge candidates to the CCP merge candidates of the chroma block unit. In some implementations, there may be one or more default CCP merge candidates. Each of the default CCP merge candidates may contain predefined CCP parameters.

With reference to FIGS. 1 and 2, the decoder module 124 may add the first on-the-fly CCP candidate of the chroma block unit to the CCP merge list. In some implementations, the number of on-the-fly CCP candidates of the chroma block unit in the CCP merge list of the chroma block unit may be an integer, equal to one.

In some other implementations, the decoder module 124 may further add the second on-the-fly CCP candidate of the chroma block unit to the CCP merge list. Thus, the number of on-the-fly CCP candidates of the chroma block unit in the CCP merge list of the chroma block unit may be an integer, greater than one. Since the on-the-fly CCP candidates of the chroma block unit are derived during the reconstruction of the chroma block unit, the precise prediction of the on-the-fly CCP candidates may be higher than the CCP merge candidates. However, the computational complexity may increase significantly if the encoder module 114 and the decoder module 124 continuously add the on-the-fly CCP candidates to the CCP merge list. Thus, the number of on-the-fly CCP candidates in the CCP merge list may be determined by considering a balance between the prediction precision and the computational complexity. In some implementations, the number of on-the-fly CCP candidates in the CCP merge list may be set to a positive number (e.g., three or four) in view of the balance between prediction precision and the computational complexity.

In some implementations, the CCP merge candidates are different from the at least one on-the-fly CCP candidate. In some implementations, the method of determining the CCP merge candidates may be different from the method of deriving the at least one on-the-fly CCP candidate.

The CCP merge candidates may include the previous CCP parameters of the CCP filter used to predict the one of the CCP-reconstructed blocks. Thus, the CCP merge candidates of the chroma block unit may be determined by directly inheriting the previous CCP parameters of the CCP-reconstructed blocks. Relatively, each of the at least one on-the-fly CCP candidates of the chroma block unit may be determined by deriving a CCP filter based on multiple neighboring samples, that neighbor a guided reference block, during the reconstruction of the chroma block unit.

In some implementations, the at least one on-the-fly CCP candidate, including the first on-the-fly CCP candidate of the chroma block unit, may be allowed to be added to the CCP merge list of the chroma block unit when the image frame is one of a random-access picture, an all-intra picture, and a gradual decoder refresh picture. In some other implementations, the at least one on-the-fly CCP candidate, including the first on-the-fly CCP candidate of the chroma block unit, may be allowed to be added to the CCP merge list of the chroma block unit when the image frame is a low delay picture.

In some implementations, the at least one on-the-fly CCP candidate may be determined based on a guiding motion vector. Thus, the guided reference block may be determined from a reference picture in the reference picture lists based on the guiding motion vector. The reference picture lists may include a first reference picture list L0 and a second reference picture list L1.

Referring back to FIG. 3, at block 370, the decoder module 124 may reconstruct the chroma block unit based on the CCP merge list of the chroma block unit.

With reference to FIGS. 1 and 2, in some implementations, the decoder module 124 may determine a prediction candidate list of the chroma block unit for reconstructing the chroma block unit. In some implementations, the prediction candidate list may include multiple prediction candidates, selected from CCP merge list and/or other prediction mode lists.

The decoder module 124 may select a prediction mode from the prediction candidates to reconstruct the chroma block unit. In some implementations, the decoder module 124 may select the prediction mode from the prediction candidates based on a prediction index. In some other implementations, the decoder module 124 may select the prediction mode directly from the CCP merge list by using a CCP merge index when the video data directly indicates that the prediction mode is selected from the CCP merge list. Thus, the decoder module 124 may select one of the CCP merge candidates and the on-the-fly CCP candidates in the CCP merge list for predicting the chroma block unit.

The decoder module 124 may determine the CCP merge index of the chroma block unit from the bitstream. The prediction mode may be a CCP prediction candidate selected from the CCP merge list of the chroma block unit by using the CCP merge index of the chroma block unit. Thus, the decoder module 124 may reconstruct the chroma block unit based on the selected CCP prediction candidate.

The selected CCP prediction candidate may be the first on-the-fly CCP candidate of the chroma block unit. In some implementations, the chroma block unit may be reconstructed based on multiple luma guided samples, included in the luma guided block of the guided reference block, by using the derived first CCP filter of the first on-the-fly CCP candidate. In some other implementations, the chroma block unit may be reconstructed based on multiple luma collocated samples, included in the luma collocated block, by using the derived first CCP filter of the first on-the-fly CCP candidate.

The selected CCP prediction candidate may be one of the CCP merge candidates of the chroma block unit. The chroma block unit may be reconstructed based on the luma collocated samples, that are included in the luma collocated block, by using an inherited CCP filter, that includes the previous CCP parameters of the one of the CCP merge candidates.

The decoder module 124 may determine multiple residual components of a residual block from the bitstream for the chroma block unit and may add the residual components to the predicted block to reconstruct the chroma block unit. The decoder module 124 may reconstruct all of the other block units in the image frame to reconstruct the image frame and the video. The method/process 300 may then end.

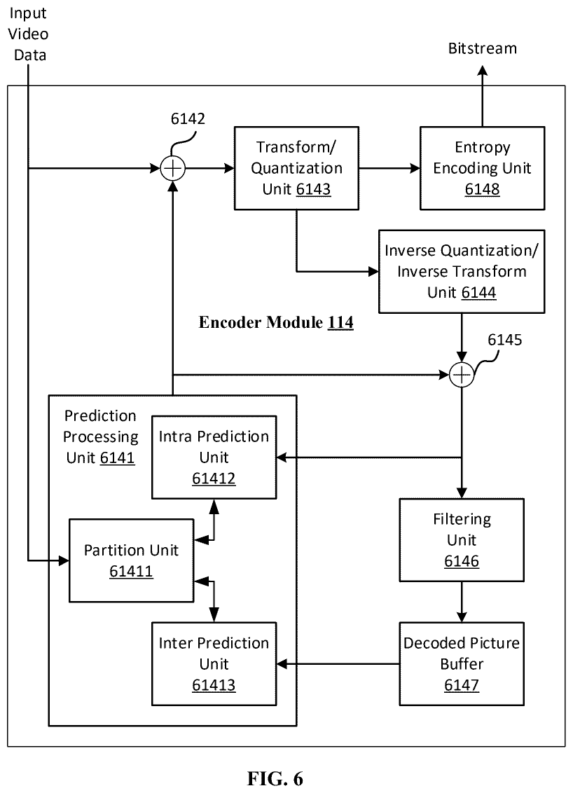

FIG. 6 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 6141), at least a first summer (e.g., a first summer 6142) and a second summer (e.g., a second summer 6145), a transform/quantization processor (e.g., a transform/quantization unit 6143), an inverse quantization/inverse transform processor (e.g., an inverse quantization/inverse transform unit 6144), a filter (e.g., a filtering unit 6146), a decoded picture buffer (e.g., a decoded picture buffer 6147), and an entropy encoder (e.g., an entropy encoding unit 6148). The prediction processing unit 6141 of the encoder module 114 may further include a partition processor (e.g., a partition unit 61411), an intra prediction processor (e.g., an intra prediction unit 61412), and an inter prediction processor (e.g., an inter prediction unit 61413). The encoder module 114 may receive the source video and encode the source video to output a bitstream.

The encoder module 114 may receive source video including multiple image frames and then divide the image frames based on a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 6141 may receive a current image block of a specific one of the image frames. The current image block may be the luminance block or one of the chrominance blocks in the specific image frame.

The partition unit 61411 may divide the current image block into multiple block units. The intra prediction unit 61412 may perform intra-predictive coding of a current block unit relative to one or more neighboring blocks in the same frame, as the current block unit, in order to provide spatial prediction. The inter prediction unit 61413 may perform inter-predictive coding of the current block unit relative to one or more blocks in one or more reference image blocks to provide temporal prediction.

The prediction processing unit 6141 may select one of the coding results generated by the intra prediction unit 61412 and the inter prediction unit 61413 based on a mode selection method, such as a cost function. The mode selection method may be a rate-distortion optimization (RDO) process.

The prediction processing unit 6141 may determine the selected coding result and provide a predicted block corresponding to the selected coding result to the first summer 6142 for generating a residual block and to the second summer 6145 for reconstructing the encoded block unit. The prediction processing unit 6141 may further provide syntax elements, such as motion vectors, intra-mode indicators, partition information, and/or other syntax information, to the entropy encoding unit 6148.

The intra prediction unit 61412 may intra-predict the current block unit. The intra prediction unit 61412 may determine an intra prediction mode directed toward a reconstructed sample neighboring the current block unit in order to encode the current block unit.

The intra prediction unit 61412 may encode the current block unit using various intra prediction modes. The intra prediction unit 61412 of the prediction processing unit 6141 may select an appropriate intra prediction mode from the selected modes. The intra prediction unit 61412 may encode the current block unit using a cross-component prediction mode to predict one of the two chroma components of the current block unit based on the luma components of the current block unit. The intra prediction unit 61412 may predict a first one of the two chroma components of the current block unit based on the second of the two chroma components of the current block unit.

The inter prediction unit 61413 may inter-predict the current block unit as an alternative to the intra prediction performed by the intra prediction unit 61412. The inter prediction unit 61413 may perform motion estimation to estimate motion of the current block unit for generating a motion vector.

The motion vector may indicate a displacement of the current block unit within the current image block relative to a reference block unit within a reference image block. The inter prediction unit 61413 may receive at least one reference image block stored in the decoded picture buffer 6147 and estimate the motion based on the received reference image blocks to generate the motion vector.

The first summer 6142 may generate the residual block by subtracting the prediction block determined by the prediction processing unit 6141 from the original current block unit. The first summer 6142 may represent the component or components that perform this subtraction.

The transform/quantization unit 6143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 6143 may perform a scan of the matrix including the quantized transform coefficients. Alternatively, the entropy encoding unit 6148 may perform the scan.

The entropy encoding unit 6148 may receive multiple syntax elements from the prediction processing unit 6141 and the transform/quantization unit 6143, including a quantization parameter, transform data, motion vectors, intra modes, partition information, and/or other syntax information. The entropy encoding unit 6148 may encode the syntax elements into the bitstream.

The entropy encoding unit 6148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 6144 may apply inverse quantization and inverse transformation to reconstruct the residual block in the pixel domain for later use as a reference block. The second summer 6145 may add the reconstructed residual block to the prediction block provided by the prediction processing unit 6141 in order to produce a reconstructed block for storage in the decoded picture buffer 6147.

The filtering unit 6146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 6145.

The decoded picture buffer 6147 may be a reference picture memory that stores the reference block to be used by the encoder module 614 to encode video, such as in intra-coding or inter-coding modes. The decoded picture buffer 6147 may include a variety of memory devices, such as DRAM (e.g., including SDRAM), MRAM, RRAM, or other types of memory devices. The decoded picture buffer 6147 may be on-chip with other components of the encoder module 114 or off-chip relative to those components.

The method/process 300 for decoding and/or encoding video data may be performed by the first electronic device 110. With reference to FIGS. 1 and 6, at block 310, the method/process 300 may start by the encoder module 114 receiving the video data. The video data received by the encoder module 114 may be a video.

At block 320, the encoder module 114 may determine a chroma block location of a chroma block unit from an image frame of the video data.

With reference to FIGS. 1 and 6, the encoder module 114 may determine the image frames from the video. A current frame may be one of the image frames. The encoder module 114 may further divide the current frame to determine the chorma block unit. In some implementations, the encoder module 114 may divide the current frame to generate multiple CTUs, and may further divide a current CTU, included in the CTUs, to generate multiple divided blocks and to determine the chroma block unit from the divided blocks.

In some implementations, only one luma collocated unit may be collocated with the chroma block unit which may be regarded as a luma collocated block when the chroma block unit is included in a single-tree block unit of the current frame. In some other implementations, at least one luma collocated unit may be covered by the luma collocated block that is collocated with the chroma block unit when the chroma block unit is included in a dual-tree block unit of the current frame. Since the luma collocated block may be predicted prior to the prediction of the chroma block unit, a luma block vector may be determined for predicting and reconstructing a portion of, or the entirety of, the luma collocated block prior to the prediction of the chroma block unit.

The size of the chroma block unit may be Wb×Hb. The size of the luma collocated block may be determined based on the size of the chroma block unit and a scaling facture SF. The scaling factor SF, that may include a width scaling factor SubWidthC and a height scaling factor SubHeightC, may be determined based on a video format. Thus, the size of the luma collocated block may be (Wb×SubWidthC)×(Hb×SubHeightC).

In addition, a luma block location of the luma collocated block may be represented by (xCb, yCb), specifying a top-left luma sample of the luma collocated block relative to a top-left luma sample of the current frame. The chroma block location of the chroma block unit may be represented by (xCb/SubWidthC, yCb/SubHeightC), specifying a top-left chroma sample of the chroma block unit relative to a top-left chroma sample of the current frame.

In some implementations, the chroma block unit and the chroma block location, determined by the encoder module 114, may be identical to the chroma block unit and the chroma block location, determined by the decoder module 124.

At block 330, the encoder module 114 may determine a guiding block vector for the chroma block unit.

With reference to FIGS. 1 and 6, the encoder module 114 may determine the guiding block vector based on a luma reference vector of a luma reference unit, covered by the luma collocated block. The luma reference unit, having the luma reference vector, may be included in the at least one luma block unit. The luma reference unit may cover at least one of multiple luma reference positions of the luma collocated block.

When a specific one of the at least one luma collocated unit, which covers at least one of the luma reference positions, is predicted based on a luma block vector, the specific luma collocated unit may be regarded, as the luma reference unit. In addition, the luma block vector of the specific luma collocated unit may be regarded, as the luma reference vector of the luma reference unit. When the guiding block vector is determined based on the luma reference vector of the luma reference unit, the guiding block vector may be identical to the luma reference vector of the luma reference unit, covered by the luma collocated block.

In some implementations, the guiding block vector of the chroma block unit, determined by the encoder module 114, may be identical to the guiding block vector of the chroma block unit, determined by the decoder module 124.

Referring back to FIG. 3, at block 340, the encoder module 114 may determine a guided reference block from the image frame based on the guiding block vector. The guided reference block may include a chroma guided block and a luma guided block.

In some implementations, the luma guided block of the guided reference block may be indicated by the guiding block vector from the luma collocated block. Thus, the guided reference block may be determined based on the luma collocated block and the guiding block vector. The luma guided block may be indicated by the guiding block vector, that starts from one of multiple guiding start positions of the luma collocated block to one of multiple guiding end positions, for determining the luma guided block. In some implementations, with reference to FIGS. 1 and 6, the guiding start positions of the luma collocated block, that is determined by the encoder module 114, may be identical to the guiding start positions of the luma collocated block, that is determined by the decoder module 124. In addition, the guiding end positions of the luma collocated block, that is determined by the encoder module 114, may be identical to the guiding end positions of the luma collocated block, that is determined by the decoder module 124.

A search order of the guiding start positions for determining the guided reference block may be predefined in the first electronic device 110 and/or the second electronic device 120. Thus, the search order of the guiding start positions, that is performed by the encoder module 114, may be identical to the search order of the guiding start positions, that is performed by the decoder module 124.

A method for determining the spatial relationship between the guiding end position and the guided reference block may be predefined in the first electronic device 110 and/or the second electronic device 120. Thus, the method for determining the spatial relationship between the guiding end position and the guided reference block, that is performed by the encoder module 114, may be identical to the method for determining the spatial relationship between the guiding end position and the guided reference block, that is performed by the decoder module 124.

In some other implementations, the luma guided block of the guided reference block may be indicated by a (N+1)-th relocated block vector of a (N+1)-th luma relocated block from the (N+1)-th luma relocated block. The (N+1)-th luma relocated block may be reconstructed by using the (N+1)-th relocated block vector. Thus, when the (N+1)-th luma relocated block is reconstructed by using the (N+1)-th relocated block vector, the encoder module 114 may determine the guided reference block from the image frame based on the (N+1)-th relocated block vector. The number (N+1) may be a relocated level of the (N+1)-th chroma relocated block.

The (N+1)-th luma relocated block may be determined from the image frame based on an N-th luma relocated block and an N-th luma relocated vector. The (N+1)-th luma relocated block may be indicated by the N-th luma relocated vector, that starts from one of multiple relocated start positions of the N-th luma relocated block to one of multiple relocated end positions, for determining the (N+1)-th luma relocated block. The search scheme for searching for the (N+1)-th luma relocated block based on the N-th luma relocated vector may be identical to, similar to, or corresponding to that for searching for the second luma relocated block based on the first luma relocated vector.

The relocated level may be equal to, or less than, a relocated level threshold. With reference to FIGS. 1 and 6, the encoder module 114 may stop determining the luma relocated block when the relocated level of the chroma relocated block is equal to the relocated level threshold. In some implementations, the relocated level threshold may be predefined in the first electronic device 110 and the second electronic device 120.

In some implementations, the method for determining the guided reference block may be predefined in the first electronic device 110 and/or the second electronic device 120. Thus, the guided reference block, determined by the encoder module 114, may be identical to the guided reference block, determined by the decoder module 124.

Referring back to FIG. 3, at block 350, the encoder module 114 may derive a first cross-component prediction (CCP) filter based on multiple first neighboring samples, neighboring the guided reference block, as a first on-the-fly CCP candidate of the chroma block unit.

With reference to FIGS. 1 and 6, the encoder module 114 may determine a block neighboring region of the guided reference block. The block neighboring region may include the first neighboring samples. In addition, the block neighboring region may include a chroma neighboring region, that neighbors the chroma guided block, and a luma neighboring region, that neighbors the luma guided block. The chroma neighboring region may include multiple chroma neighboring samples, that neighbor the chroma guided block. The luma neighboring region may include multiple luma neighboring samples, that neighbor the luma guided block.

In some implementations, the encoder module 114 may derive the first CCP filter based on the chroma neighboring samples and the luma neighboring samples using a down-sampling filter or a sub-sampling filter. Multiple luma scaled samples of the luma neighboring region may be derived, based on the scaling factor, by using the down-sampling filter or the sub-sampling filter. Thus, the first CCP filter may be derived based on the chroma neighboring samples of the chroma neighboring region and the luma scaled samples of the luma neighboring region.

In some implementations, the first CCP filter may be generated by deriving multiple filter coefficients of a predefined chroma filter based on the luma scaled samples and the chroma neighboring samples. The encoder module 114 may derive the filter coefficients of the predefined chroma filter to determine the first CCP filter based on the luma scaled samples and the chroma neighboring samples. In some implementations, the derivation method for deriving the first CCP filter may be predefined in the first electronic device 110 and/or the second electronic device 120. Thus, the first CCP filter, derived by the encoder module 114, may be identical to the first CCP filter, derived by the decoder module 124.

Since the first CCP filter is derived based on the chroma neighboring samples and the luma scaled samples during the reconstruction of the chroma block unit, the first CCP filter may be determined, as the first on-the-fly CCP candidate of the chroma block unit. Furthermore, the encoder module 114 may determine a second on-the-fly CCP candidate of the chroma block unit by deriving a second CCP filter during the reconstruction of the chroma block unit. In some implementations, the derivation method for deriving other CCP filters may be predefined in the first electronic device 110 and/or the second electronic device 120. Thus, other CCP filters, including the second CCP filter, derived by the encoder module 114, may be identical to other CCP filters, including the second CCP filter, derived by the decoder module 124.

Referring back to FIG. 3, at block 360, the encoder module 114 may determine a CCP merge list of the chroma block unit, the CCP merge list including multiple CCP merge candidates of the chroma block unit and the first on-the-fly CCP candidate of the chroma block unit.

With reference to FIGS. 1 and 6, the encoder module 114 may determine the CCP merge candidates of the chroma block unit to construct the CCP merge list of the chroma block unit. Multiple previous CCP parameters in the CCP merge candidates of the chroma block unit may be used to reconstruct multiple chroma coding units prior to reconstructing the chroma block unit. Each of the CCP merge candidates of the chroma block unit may be determined according to one of multiple predefined CCP merge candidates.

In some implementations, the determination method for determining the CCP merge candidates of the chroma block unit may be predefined in the first electronic device 110 and/or the second electronic device 120. Thus, the CCP merge candidates of the chroma block unit, determined by the encoder module 114, may be identical to the CCP merge candidates of the chroma block unit, determined by the decoder module 124.

The encoder module 114 may add the first on-the-fly CCP candidate of the chroma block unit into the CCP merge list. In addition, the encoder module 114 may further add the second on-the-fly CCP candidate of the chroma block unit into the CCP merge list. In some implementations, the on-the-fly CCP candidates of the CCP merge list, used by the encoder module 114, may be identical to the on-the-fly CCP candidates of the CCP merge list, used by the decoder module 124.

In some implementations, the at least one on-the-fly CCP candidate, including the first on-the-fly CCP candidate of the chroma block unit, may be allowed to be added to the CCP merge list of the chroma block unit when the image frame is one of a random-access picture, an all-intra picture, and a gradual decoder refresh picture. In some other implementations, the at least one on-the-fly CCP candidate, including the first on-the-fly CCP candidate of the chroma block unit, may be allowed to be added to the CCP merge list of the chroma block unit when the image frame is a low delay picture.

In some implementations, the at least one on-the-fly CCP candidate may be determined based on a guiding motion vector. Thus, the guided reference block may be determined from a reference picture in the reference picture lists based on the guiding motion vector. The reference picture lists may include a first reference picture list L0 and a second reference picture list L1.

Referring back to FIG. 3, at block 370, the encoder module 114 may reconstruct the chroma block unit based on the CCP merge list of the chroma block unit.

With reference to FIGS. 1 and 6, in some implementations, the encoder module 114 may determine a prediction candidate list of the chroma block unit for predicting and/or reconstructing the chroma block unit. The prediction candidate list may include multiple prediction candidates, selected from CCP merge list and/or other prediction mode lists. In some implementations, the encoder module 114 may predict the chroma block unit based on each of the prediction candidates, including the CCP merge candidates the first on-the-fly CCP candidates, to generate multiple chroma predicted blocks.

The encoder module 114 may select one of the chroma predicted blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, or a Structural SIMilarity (SSIM) process. The encoder module 114 may provide the selected coding result to the first summer 6142 for generating a chroma residual block and to the second summer 6145 for reconstructing the encoded chroma block unit.

The encoder module 114 may further encode the syntax elements into a bitstream, for transmitting to the decoder module 124. The syntax elements of the chroma block unit may be used to determine a selected prediction candidate corresponding to the selected chroma predicted block. The syntax elements of the chroma block unit may include a CCP merge index. The CCP merge index may be used to determine the selected prediction candidate from CCP merge list.

In some implementations, the syntax elements, associated with the chroma block unit, may further include multiple partition indications generated based on the partitioning of the chroma block unit (e.g., based on any video coding standard).

When the selected prediction candidate is the first on-the-fly CCP candidate of the chroma block unit, the encoder module 114 may predict the chroma block unit based on the first CCP filter, to generate the chroma predicted block. The encoder module 114 may determine multiple chroma residual components of the chroma residual block for the chroma block unit based on the chroma predicted block. In addition, the encoder module 114 may add the chroma residual components back into the chroma predicted block to reconstruct the chroma block unit.

The reconstruction of the chroma block unit by the encoder module 114 may be identical to the reconstruction of the chroma block unit by the decoder module 124. The method/process 300 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a chroma block location of a chroma block unit from an image frame of the video data;
determine a guiding block vector for the chroma block unit;
determine a guided reference block from the image frame based on the guiding block vector;
derive a first cross-component prediction (CCP) filter based on a plurality of first neighboring samples, neighboring the guided reference block, as a first on-the-fly CCP candidate of the chroma block unit;
determine a CCP merge list of the chroma block unit, the CCP merge list including a plurality of CCP merge candidates of the chroma block unit and the first on-the-fly CCP candidate of the chroma block unit, wherein the plurality of CCP merge candidates of the chroma block unit is used to reconstruct a plurality of chroma coding units prior to reconstructing the chroma block unit; and
reconstruct the chroma block unit based on the CCP merge list of the chroma block unit.

2. The non-transitory machine-readable medium of claim 1, wherein the one or more computer-executable instructions, when executed by the at least one processor of the electronic device, further cause the electronic device to:
determine a CCP merge index of the chroma block unit from the video data; and
select a CCP prediction candidate from the CCP merge list of the chroma block unit by using the CCP merge index of the chroma block unit, wherein:
reconstructing the chroma block unit based on the CCP merge list of the chroma block unit comprises reconstructing the chroma block unit based on the selected CCP prediction candidate, and
when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and a plurality of luma guided samples that is included in the guided reference block.

3. The non-transitory machine-readable medium of claim 1, wherein the one or more computer-executable instructions, when executed by the at least one processor of the electronic device, further cause the electronic device to:
determine a luma collocated block from the image frame, the luma collocated block collocated with the chroma block unit and reconstructed by using the guiding block vector;
determine a chroma guided block and a luma guided block, both of which being included in the guided reference block, wherein the luma guided block is indicated by the guiding block vector from the luma collocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

4. The non-transitory machine-readable medium of claim 1, wherein determining the guided reference block from the image frame based on the guiding block vector comprises:
determining, from the image frame, a first luma relocated block that is indicated by the guiding block vector, wherein:
the guiding block vector starts from a luma collocated block, and
the luma collocated block, collocated with the chroma block unit and included in the image frame, is reconstructed by using the guiding block vector; and
when the first luma relocated block is reconstructed by using a first relocated block vector, determining the guided reference block from the image frame based on the first relocated block vector.

5. The non-transitory machine-readable medium of claim 4, wherein the one or more computer-executable instructions, when executed by the at least one processor of the electronic device, further cause the electronic device to:
determine a chroma guided block and a luma guided block, both of which being included in the guided reference block, wherein the luma guided block is indicated by the first relocated block vector from the first luma relocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

6. The non-transitory machine-readable medium of claim 4, wherein determining the guided reference block from the image frame based on the first relocated block vector comprises:
determining, from the image frame, a second luma relocated block that is indicated by the first luma relocated vector, the first luma relocated vector starting from the first luma relocated block; and
when the second luma relocated block is reconstructed by using a second relocated block vector, determining the guided reference block from the image frame based on the second relocated block vector.

7. The non-transitory machine-readable medium of claim 1, wherein when the image frame is one of a random-access picture, an all-intra picture, and a gradual decoder refresh picture, the first on-the-fly CCP candidate of the chroma block unit is allowed to be added to the CCP merge list of the chroma block unit.

8. The non-transitory machine-readable medium of claim 1, wherein the one or more computer-executable instructions, when executed by the at least one processor of the electronic device, further cause the electronic device to:
derive a second CCP filter based on a plurality of second neighboring samples, neighboring a luma relocated block, as a second on-the-fly CCP candidate of the chroma block unit, wherein the luma relocated block is indicated from the guided reference block by a relocated block vector of the guided reference block; and
add the second on-the-fly CCP candidate of the chroma block unit to the CCP merge list of the chroma block unit, wherein the number of the on-the-fly CCP candidates of the chroma block unit in the CCP merge list of the chroma block unit is greater than one.

9. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block location of a chroma block unit from an image frame of the video data;
determine a guiding block vector for the chroma block unit;
determine a guided reference block from the image frame based on the guiding block vector;
derive a first cross-component prediction (CCP) filter based on a plurality of neighboring samples, neighboring the guided reference block, as a first on-the-fly CCP candidate of the chroma block unit;
determine a CCP merge list of the chroma block unit, the CCP merge list including a plurality of CCP merge candidates of the chroma block unit and the first on-the-fly CCP candidate of the chroma block unit, wherein the plurality of CCP merge candidates of the chroma block unit is used to reconstruct a plurality of chroma coding units prior to reconstructing the chroma block unit; and
reconstruct the chroma block unit based on the CCP merge list of the chroma block unit.

10. The electronic device of claim 9, wherein the one or more computer-executable instructions, when executed by the at least one processor of the electronic device, further cause the electronic device to:
determine a CCP merge index of the chroma block unit from the video data; and
select a CCP prediction candidate from the CCP merge list of the chroma block unit by using the CCP merge index of the chroma block unit, wherein:
reconstructing the chroma block unit based on the CCP merge list of the chroma block unit comprises reconstructing the chroma block unit based on the selected CCP prediction candidate, and
when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and a plurality of luma guided samples that is included in the guided reference block.

11. The electronic device of claim 9, wherein the one or more computer-executable instructions, when executed by the at least one processor of the electronic device, further cause the electronic device to:
determine a luma collocated block from the image frame, the luma collocated block collocated with the chroma block unit and reconstructed by using the guiding block vector;
determine a chroma guided block and a luma guided block, both of which being included in the guided reference block, wherein the luma guided block is indicated by the guiding block vector from the luma collocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

12. The electronic device of claim 9, wherein determining the guided reference block from the image frame based on the guiding block vector comprises:
determining, from the image frame, a first luma relocated block that is indicated by the guiding block vector, wherein:
the guiding block vector starts from a luma collocated block, and
the luma collocated block, collocated with the chroma block unit and included in the image frame, is reconstructed by using the guiding block vector; and
when the first luma relocated block is reconstructed by using a first relocated block vector, determining the guided reference block from the image frame based on the first relocated block vector.

13. The electronic device of claim 12, wherein the one or more computer-executable instructions, when executed by the at least one processor of the electronic device, further cause the electronic device to:
determine a chroma guided block and a luma guided block, both of which being included in the guided reference block, wherein the luma guided block is indicated by the first relocated block vector from the first luma relocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

14. The electronic device of claim 12, wherein determining the guided reference block from the image frame based on the first relocated block vector comprises:
determining, from the image frame, a second luma relocated block that is indicated by the first luma relocated vector, the first luma relocated vector starting from the first luma relocated block; and
when the second luma relocated block is reconstructed by using a second relocated block vector, determining the guided reference block from the image frame based on the second relocated block vector.

15. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a chroma block location of a chroma block unit from an image frame of the video data;
determine a guiding block vector for the chroma block unit;
determine a guided reference block from the image frame based on the guiding block vector;
derive a first cross-component prediction (CCP) filter based on a plurality of neighboring samples, neighboring the guided reference block, as a first on-the-fly CCP candidate of the chroma block unit;
determine a CCP merge list of the chroma block unit, the CCP merge list including a plurality of CCP merge candidates of the chroma block unit and the first on-the-fly CCP candidate of the chroma block unit, wherein the plurality of CCP merge candidates of the chroma block unit is used to reconstruct a plurality of chroma coding units prior to reconstructing the chroma block unit; and
reconstruct the chroma block unit based on the CCP merge list of the chroma block unit.

16. The electronic device of claim 15, wherein the one or more computer-executable instructions, when executed by the at least one processor of the electronic device, further cause the electronic device to:
determine a CCP merge index of the chroma block unit from the video data; and
select a CCP prediction candidate from the CCP merge list of the chroma block unit by using the CCP merge index of the chroma block unit, wherein:
reconstructing the chroma block unit based on the CCP merge list of the chroma block unit comprises reconstructing the chroma block unit based on the selected CCP prediction candidate, and
when the selected CCP prediction candidate is the first on-the-fly CCP candidate of the chroma block unit, reconstructing the chroma block unit based on the CCP merge list of the chroma block unit comprises reconstructing the chroma block unit by using the first CCP filter and a plurality of luma guided samples that is included in the guided reference block.

17. The electronic device of claim 15, wherein the one or more computer-executable instructions, when executed by the at least one processor of the electronic device, further cause the electronic device to:
determine a luma collocated block from the image frame, the luma collocated block collocated with the chroma block unit and reconstructed by using the guiding block vector;
determine a chroma guided block and a luma guided block, both of which being included in the guided reference block, wherein the luma guided block is indicated by the guiding block vector from the luma collocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

18. The electronic device of claim 15, wherein determining the guided reference block from the image frame based on the guiding block vector comprises:
determining, from the image frame, a first luma relocated block that is indicated by the guiding block vector, wherein:
the guiding block vector starts from a luma collocated block, and
the luma collocated block, collocated with the chroma block unit and included in the image frame, is reconstructed by using the guiding block vector; and
when the first luma relocated block is reconstructed by using a first relocated block vector, determining the guided reference block from the image frame based on the first relocated block vector.

19. The electronic device of claim 18, wherein the one or more computer-executable instructions, when executed by the at least one processor of the electronic device, further cause the electronic device to:
determine a chroma guided block and a luma guided block, both of which being included in the guided reference block, wherein the luma guided block is indicated by the first relocated block vector from the first luma relocated block;
determine a plurality of chroma neighboring samples in a chroma neighboring region, neighboring the chroma guided block; and
determine a plurality of luma neighboring samples in a luma neighboring region, neighboring the luma guided block,
wherein the plurality of chroma neighboring samples and the plurality of luma neighboring samples are included in the plurality of first neighboring samples.

20. The electronic device of claim 15, wherein when the image frame is one of a random-access picture, an all-intra picture, and a gradual decoder refresh picture, the first on-the-fly CCP candidate of the chroma block unit is allowed to be added to the CCP merge list of the chroma block unit.
